(19) United States
(12) Patent Application Publication
(10) Pub. No.: US 2025/0024118 A1
(43) Pub. Date: Jan. 16, 2025

(54) METHOD, DEVICE, AND COMPUTER PROGRAM FOR IMPROVING SIGNALING OF MULTIPLE TRANSFORMATIONS APPLYING TO ENCAPSULATED MEDIA DATA

(71) Applicant: CANON KABUSHIKI KAISHA, Tokyo (JP)

(72) Inventors: Hervé RUELLAN, Rennes (FR); Franck DENOUAL, Saint Domineuc (FR); Lionel TOCZE, Saint Domineuc (FR); Jean LE FEUVRE, Gometz-le-Châtel (FR)

(21) Appl. No.: 18/767,739

(22) Filed: Jul. 9, 2024

(30) Foreign Application Priority Data
Jul. 10, 2023 (GB) 2310591.9

(51) Int. Cl. H04N 21/84; H04N 21/854

(52) U.S. Cl. CPC H04N 21/84; H04N 21/85406

(57) ABSTRACT

At least one embodiment of a method for encapsulating media data in a file, in a processing device, the media data comprising a plurality of samples, at least one sample being to be transformed by at least one transformation, the method comprising generating a track comprising the at least one sample to be transformed and descriptive metadata, the descriptive metadata comprising an indication that the track is restricted and a first restricted scheme description data structure comprising a first restriction scheme type indicating that at least one sample of the track is associated with at least one essential sample group description, wherein the first restricted scheme description data structure further comprises a second restricted scheme description data structure describing the at least one transformation and its parameters.

### CROSS REFERENCE TO RELATED APPLICATION

This application claims the benefit under 35 U.S.C. § 119 (a)-(d) of United Kingdom Patent Application No. 2310591.9, filed on Jul. 10, 2023 and entitled “METHOD, DEVICE, AND COMPUTER PROGRAM FOR IMPROVING SIGNALING OF MULTIPLE TRANSFORMATIONS APPLYING TO ENCAPSULATED MEDIA DATA”. The above cited patent application is incorporated herein by reference in its entirety.

### FIELD OF THE INVENTION

The present disclosure relates to a method, a device, and a computer program for improving the encapsulation and parsing of media data, making it possible to improve signalling of multiple transformations or processing applying to encapsulated media data.

### BACKGROUND OF THE INVENTION

The International Standard Organization Base Media File Format (ISO BMFF, ISO/IEC 14496-12) is a well-known flexible and extensible format that describes encoded timed or non-timed media data or bit-streams either for local storage or for transmission via a network or via another bit-stream delivery mechanism. This file format has several extensions, e.g. Part-15, ISO/IEC 14496-15 that describes encapsulation tools for various NAL (Network Abstraction Layer) unit-based video encoding formats. Examples of such encoding formats are AVC (Advanced Video Coding), SVC (Scalable Video Coding), HEVC (High Efficiency Video Coding), L-HEVC (Layered HEVC), and VVC (Versatile Video Coding). Another example of file format extension is ISO/IEC 23008-12 that describes encapsulation tools for still images or for sequence of still images such as HEVC Still Image. Still another example of file format extension is ISO/IEC 23090-2 that defines the omnidirectional media application format (OMAF). Still other examples of file format extension are ISO/IEC 23090-10 and ISO/IEC 23090-18 that define the carriage of Visual Volumetric Video-based Coding (V3C) media data and Geometry-based Point Cloud Compression (G-PCC) media data.

This file format is object-oriented. It is composed of building blocks called boxes (or data structures, each of which being identified by a four-character code, also denoted FourCC or 4CC). Full boxes are data structures similar to boxes, further comprising a version and flag value attributes. In the following, the term box may designate both full boxes or boxes. These boxes or full boxes are sequentially or hierarchically organized. They define parameters describing the encoded timed or non-timed media data or bit-stream, their structure and the associated timing, if any. In the following, it is considered that encapsulated media data designate encapsulated data comprising metadata and media data (the latter designating the bit-stream that is encapsulated). All data in an encapsulated media file (media data and metadata describing the media data) is contained in boxes. There is no other data within the file. File-level boxes are boxes that are not contained in other boxes.

According to the file format, the overall presentation (or session) over the time is called a movie. The movie is described within a movie box (identified with the four-character code ‘moov’) at the top level of the media or presentation file. This movie box represents an initialization information container containing a set of various boxes describing the presentation. It may be logically divided into tracks represented by track boxes (identified with the four-character code ‘trak’). Each track (uniquely identified by a track identifier (track_ID)) represents a timed sequence of media data pertaining to the presentation (for example a sequence of video frames or of subparts of video frames). Within each track, each timed unit of media data is called a sample. Such a timed unit may be a video frame or a subpart of a video frame, a sample of audio, or a set of timed metadata. Samples are implicitly numbered in an increasing decoding order. Each track box contains a hierarchy of boxes describing the samples of the corresponding track.

Among this hierarchy of boxes, a sample table box (identified with the four-character code ‘stbr’) contains all the items of time information and data indexing of the media samples in a track. In addition, the ‘stbl’ box contains, in particular, a sample description box (identified with the four-character code ‘stsd’) containing a set of sample entries, each sample entry giving required information about the coding configuration (including a coding type identifying the coding format and various coding parameters characterizing the coding format) of media data in a sample, and any initialization information needed for decoding the sample. The actual sample data are stored in boxes called media data boxes (identified with the four-character code ‘mdat’) or called identified media data boxes (identified with the four-character code ‘imda’, similar to the media data box but containing an additional identifier). The media data boxes and the identified media data boxes are located at the same level as the movie box.

ISOBMFF and its extensions comprise the definition of sample entries for signalling that the file author requires certain actions, for example transformations to be applied to the media samples by the player or renderer. For example, there are sample entries for signalling the protection of media samples, such as the encryption of the media samples: for instance a protected sample entry for video is identified with the four-character code ‘encv’ and a protected sample entry for audio is identified with the four-character code ‘enca’. There are also sample entries for signalling that rendering the media requires further processing. These latter sample entries are named restricted sample entries (for example a restricted sample entry for video is identified with the four-character code ‘resv’ and a restricted sample entry for audio is identified with the four-character code ‘resa’). An original sample entry, indicating for example the codec in use to compress the samples, is said to be transformed into a restricted sample entry. Historically, the transformations applied to the media samples can be further detailed in boxes contained in the sample entries. For a protected sample entry, the description of the transformation is signalled in a ProtectionSchemeInfoBox (identified with the four-character code ‘sinf’). For a restricted sample entry, the description of the transformation is signalled in a RestrictedSchemeInfoBox (identified with the four-character code ‘rinf’). The ProtectionSchemeInfoBox and the RestrictedSchemeInfoBox contain other boxes for signalling different parts of this description. The OriginalFormatBox box (identified with the four-character code ‘frma’) contains the four-character code of the original un-transformed sample entry. The SchemeTypeBox box (identified with the four-character code ‘schm’) identifies the protection or restriction scheme used using the scheme_type field of this box that stores the four-character code corresponding to the scheme used. The SchemeInformationBox box (identified with the four-character code ‘schi’) stores any information needed by the protection or restriction scheme used.

In addition, ISOBMFF and its extensions comprise several grouping mechanisms to group together tracks, static items, or samples and to associate a group description with a group. The samples of a group typically share common semantics and/or characteristics. For example, a MovieBox box and/or MovieFragmentBox boxes may contain sample groups associating properties to a group of samples for a track. The sample groups are characterized by a grouping type and may be defined by two linked boxes, a SampleToGroupBox (‘sbgp’) box that represents the assignment of samples to sample groups and a SampleGroupDescriptionBox (‘sgpd’) box that contains a sample group entry for each sample group that describes the properties of the group.

A SampleGroupDescriptionBox box may be signalled as essential to indicate that it describes essential information for the associated samples and that parsers should not attempt to process a track containing a SampleGroupDescriptionBox box marked as essential that it doesn't recognize. The essential descriptions hierarchy sample group (identified with the four-character code ‘esgh’) indicates ordering of the essential sample group description entries applying to a given sample. This ordering is signalled by listing the four-character codes of the grouping_type value of the different essential sample group description entries. This essential descriptions hierarchy sample group may also indicate the position in the transformation chain of the decoding process, using the four-character code ‘stsd’, of the protection removal, using the four-character code ‘cenc’, and/or of the processing associated with a restricted sample entry, using the four-character code of the scheme_type value corresponding to the processing. A sample associated with an essential descriptions hierarchy sample group is described with a restricted sample entry with a scheme_type equal to ‘essg’.

The movie may also be fragmented, i.e., organized temporally as a movie box containing information for the whole presentation followed by a list of movie fragments, i.e., a list of couples comprising a movie fragment box (identified with the four-character code ‘moof’) and a media data box (‘mdat’) or a list of couples comprising a movie fragment box (‘moof’) and an identified media data box (‘imda’).

FIG. 1 illustrates an example of encapsulated media data temporally organized as a fragmented presentation in one or more media files according to the ISO Base Media File Format.

The media data encapsulated in the one or more media files 100 starts with a FileTypeBox (‘ftyp’) box (not illustrated) providing a set of brands identifying the precise specifications to which the encapsulated media data conforms. These brands are used by a reader to determine whether it can process the encapsulated media data. The ‘ftyp’ box is followed by a MovieBox (‘moov’) box referenced 105. The MovieBox box provides initialization information that is needed for a reader to initiate processing of the encapsulated media data. In particular, it provides a description of the presentation content, the number of tracks, and information regarding their respective timelines and characteristics. For the sake of illustration, the MovieBox box may indicate that the presentation comprises one track having an identifier track_ID equal to 1.

As illustrated, MovieBox box 105 is followed by one or more movie fragments (also called media fragments), each movie fragment comprising metadata stored in a MovieFragmentBox (‘moof’) box and media data stored in a MediaDataBox (‘mdat’) box. For the sake of illustration, the one or more media files 100 comprises a first movie fragment containing and describing samples 1 to N of a track identified with track_ID equal to 1. This first movie fragment is composed of ‘moof’ box 110 and of ‘mdat’ box 115.

When the encapsulated media data is fragmented into a plurality of files, the File TypeBox and MovieBox boxes (also denoted initialization fragment in the following) are contained within an initial media file (also denoted an initialization segment), in which the track(s) contain no samples. Subsequent media files (also denoted media segments) contain one or more movie fragments.

Among other information, ‘moov’ box 105 may contain a MovieExtendsBox (‘mvex’) box (not illustrated). When present, information contained in this box warns readers that there might be subsequent movie fragments and that these movie fragments must be found and scanned in the given order to obtain all the samples of a track. To that end, information contained in this box should be combined with other information of the MovieBox box. The MovieExtendsBox box may contains an optional MovieExtendsHeaderBox (‘mehd’) box and one TrackExtendsBox (‘trex’) box per track defined in MovieBox box 105. When present, the MovieExtendsHeaderBox box provides the overall duration of a fragmented movie. Each TrackExtendsBox box defines default parameter values used by the associated track in the movie fragments.

As illustrated, ‘moov’ box 105 also contains one or more TrackBox (‘trak’) boxes 120 describing each track in the presentation. TrackBox box 120 contains in its box hierarchy a SampleTableBox (‘stbl’) box that in turn contains descriptive and timing information for the media samples of the track. In particular, it contains a SampleDescriptionBox (‘stsd’) box containing one or more SampleEntry boxes giving descriptive information about the coding format of the samples (the coding format being identified with a 4CC), and initialization information needed for configuring a decoder according to the coding format.

For instance, a SampleEntry box having a four-character type set to ‘vvc1’ or ‘vvi1’ signals that the associated samples contain media data encoded according to the Versatile Video Coding (VVC) format and a SampleEntry box having a Four-character type set to ‘hvc1’ or ‘hev1’ signals that the associated samples contain media data encoded according to the High Efficiency Video Coding (HEVC) format. The SampleEntry box may contain other boxes containing information that applies to all samples associated with this SampleEntry box.

Samples are associated with a SampleEntry box via the sample_description_index parameter either in a SampleToChunkBox (‘stsc’) box in the SampleTableBox (‘stbl’) box when the media file is a non-fragmented media file, or otherwise in a TrackFragmentHeaderBox (‘tfhd’) box in a TrackFragmentBox (‘traf’) box of the MovieFragmentBox (‘moof’) box or in a TrackExtendsBox (‘trex’) box in a MovieExtendsBox (‘mvex’) box when the media file is fragmented.

According to ISO Base Media File Format, all tracks and all sample entries in a presentation are defined in ‘moov’ box 105 and cannot be declared later on during the presentation.

It is observed that a movie fragment may contain samples for one or more of the tracks declared in the ‘moov’ box, but not necessarily for all of the tracks. The MovieFragmentBox box 110 contains a TrackFragmentBox (‘traf’) box including a TrackFragmentHeaderBox (‘tfhd’) box (not represented) providing an identifier (e.g. Track_ID=1) identifying each track for which samples are contained in the ‘mdat’ box 115 of the movie fragment. Among other information, the ‘traf’ box contains one or more TrackRunBox (‘trun’) boxes documenting a contiguous set of samples for a track in the movie fragment.

An ISOBMFF file or segment may contain multiple sets of encoded timed media data (also denoted bit-streams or streams) or sub-parts of sets of encoded timed media data (also denoted sub-bit-streams or sub-streams) forming multiple tracks. When the sub-parts correspond to one or successive spatial parts of a video source, taken over the time (e.g., at least one rectangular region, also known as ‘tile’ or ‘sub-picture’, taken over the time), the corresponding multiple tracks may be called tile tracks or sub-picture tracks.

As illustrated, a SampleGroupDescriptionBox with a grouping_type equal to ‘esgh’ is used to signal that an essential descriptions hierarchy sample group is used. Accordingly, the type of the SampleEntry is ‘resv’, corresponding to a restricted sample entry for a video media. The processing corresponding to this restricted sample entry is signalled by the scheme_type value ‘essg’ of the RestrictedSchemeInfoBox (‘schm’) box.

The original four-character code corresponding to the original type of the samples, for instance ‘vvc1’, or ‘vvi1’, may be signalled in the OriginalFormatBox (‘frma’) box. The content of the SampleGroupDescriptionEntry (not shown) contained in the SampleGroupDescriptionBox lists the processing order for the different transformations applied to the samples.

As described above, ISOBMFF defines some processing operations or transformations to the samples as restricted sample entries and scheme types. In addition, essential sample groups have been introduced to offer more flexibility in the descriptions of transformations or specific operations that a player should support to render a track. For backward compatibility reason, it has been decided to keep on indicating that samples may be transformed by using restricted sample entries. However, due to the ISOBMFF box structure (only one RestrictedSchemeInfoBox in a sample entry), it is not possible to combine the indication of essential sample group with a transformation historically described as a restricted sample entry.

### SUMMARY OF THE INVENTION

The present disclosure has been devised to address one or more of the foregoing concerns.

According to a first aspect of the disclosure, there is provided a method for encapsulating media data, by a processing device, the method comprising:

generating a track comprising a sample of the media data and descriptive metadata, the descriptive metadata comprising:
an indication that the track is restricted, and
a first restricted scheme description data structure comprising a first restriction scheme type indicating that the sample of the track is associated an essential sample group description;
   wherein the first restricted scheme description data structure further comprises a second restricted scheme description data structure describing a transformation to be applied to the sample.

Accordingly, the method of the disclosure makes it possible to allow transformations described using a restricted sample entry to be used jointly with an essential descriptions hierarchy sample group (‘esgh’ sample group) and to handle the different sets of transformations for different sets of samples.

According to some embodiments, the second restricted scheme description data structure further comprises a parameter of the transformation.

Still according to some embodiments, the descriptive metadata further comprises an indication indicating a processing order of the transformation relatively to another transformation to be applied to the sample.

Still according to some embodiments, the indication indicating the processing order is comprised in the essential sample group description.

Still according to some embodiments, the descriptive metadata further comprises another essential sample group description describing the another transformation or essential information for the sample.

Still according to some embodiments, the first restricted scheme description data structure further comprises a third restricted scheme description data structure describing the another transformation to be applied to the sample.

Still according to some embodiments, only the first restricted scheme description data structure comprises an indication of the un-transformed format of the sample.

Still according to some embodiments, the second and third restricted scheme description data structures are comprised in a scheme information data structure in the first restricted scheme description data structure.

Still according to some embodiments, the generated track is encapsulated in an ISOBMFF-based file.

According to a second aspect of the disclosure, there is provided a method for processing encapsulated media data, by a processing device, the method comprising: Obtaining, from a track of the encapsulated media data, a sample and descriptive metadata, the descriptive metadata comprising:
an indication that the track is restricted, and
a first restricted scheme description data structure comprising a first restriction scheme type indicating that the sample of the track is associated with an essential sample group description, wherein the first restricted scheme description data structure further comprises a second restricted scheme description data structure describing a transformation to be applied to the sample, and
applying the transformation to the obtained sample.

Accordingly, the method of the disclosure makes it possible to allow transformations described using a restricted sample entry to be used jointly with an essential descriptions hierarchy sample group (‘esgh’ sample group) and to handle the different sets of transformations for different sets of samples.

Accordingly, the method of the disclosure makes it possible to allow transformations described using a restricted sample entry to be used jointly with the ‘esgh’ sample group and to handle the different sets of transformations for different sets of samples.

Still according to some embodiments, the second restricted scheme description data structure further comprises a parameter of the transformation.

Still according to some embodiments, the descriptive metadata further comprises an indication indicating a processing order of the transformation relatively to another transformation to be applied to the sample.

Still according to some embodiments, the indication indicating the processing order is comprised in the essential sample group description.

Still according to some embodiments, the descriptive metadata further comprises another essential sample group description describing the another transformation or essential information for the sample.

Still according to some embodiments, the first restricted scheme description data structure further comprises a third restricted scheme description data structure describing the another transformation to be applied to the sample.

Still according to some embodiments, only the first restricted scheme description data structure comprises an indication of the un-transformed format of the sample.

Still according to some embodiments, the media data is encapsulated in an ISOBMFF-based file.

According to other aspects of the disclosure, there is provided a processing device comprising a processing unit configured for carrying out each step of the methods described above. The other aspects of the present disclosure have optional features and advantages similar to the first and second above-mentioned aspects.

At least parts of the methods according to some embodiments of the disclosure may be computer implemented. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit”, a “module”, or a “system”. Furthermore, some embodiments of the present disclosure may take the form of a computer program product embodied in any tangible medium of expression having computer usable program code embodied in the medium.

Since some embodiments of the present disclosure can be implemented in software, some embodiments of the present disclosure can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device, and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Embodiments of the disclosure will now be described, by way of example only, and with reference to the following drawings in which:

FIG. 1 illustrates an example of a structure of fragmented media data that are encapsulated according to the ISO Base Media File Format;

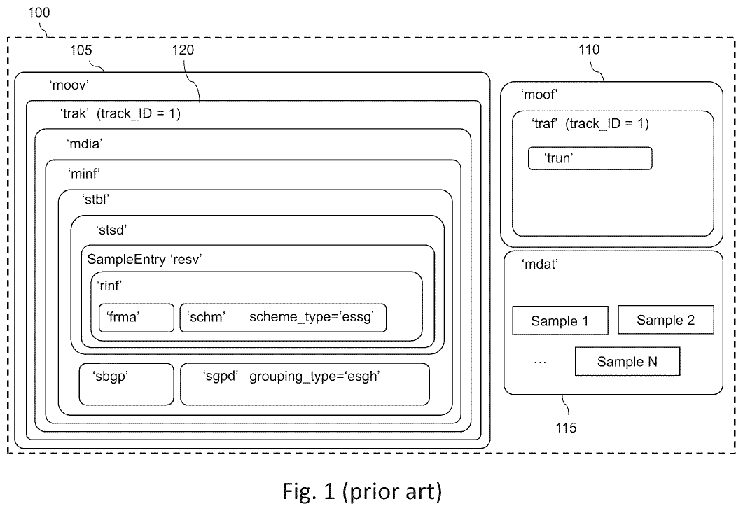

FIG. 2 illustrates an example of a system wherein some embodiments of the disclosure may be carried out;

FIG. 3 is a block diagram illustrating an example of steps carried out by a server or writer to encapsulate encoded media data according to some embodiments of the disclosure;

FIGS. 4 and 5 illustrate examples of a structure of metadata for describing sets of ordered transformations to be applied to samples, according to a first and a second embodiments of the disclosure;

FIG. 6 is a block diagram illustrating an example of steps carried out by a client or reader to process encapsulated media data, according to some embodiments of the disclosure;

FIG. 7 illustrates a media stream encapsulated using some embodiments of the disclosure; and

FIG. 8 schematically illustrates an example of a processing device configured to implement at least one embodiment of the present disclosure

### DETAILED DESCRIPTION OF THE INVENTION

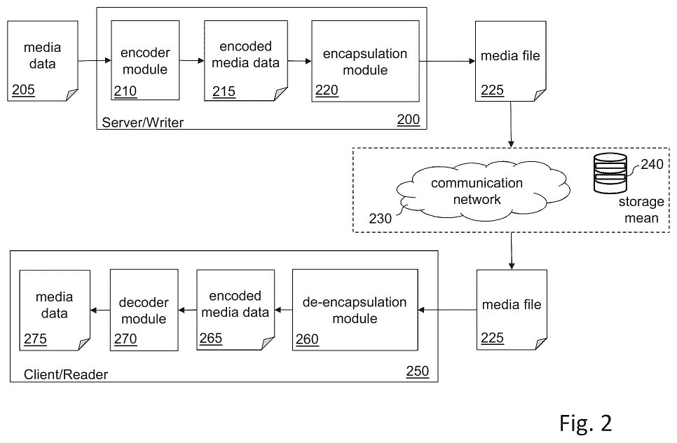

FIG. 2 illustrates an example of a system wherein some embodiments of the disclosure may be carried out.

As illustrated, a server or writer referenced 200 is connected, via a network interface (not represented), to a communication network 230 to which is also connected, via a network interface (not represented), to a client or reader 250, making it possible for server or writer 200 and client or reader 250 to exchange a media file referenced 225 via communication network 230.

According to other embodiments, server or writer 200 may exchange media file 225 with client or reader 250 via storage means, for example the storage means referenced 240. Such storage means can be for example a memory module (e.g., Random Access Memory (RAM)), a hard disk, a solid-state drive, or any removable digital medium for example such as a disk or memory card.

According to the illustrated example, server or writer 200 aims at processing media data, for example the media data referenced 205, e.g., video data, audio data, and/or descriptive metadata, for streaming or for storage purposes. To that end, server or writer 200 obtains or receives a media content comprising original media data or bit-streams 205, e.g., one or more timed sequences of images, timed sequences of audio sample, or timed sequences of descriptive metadata, and encodes the obtained media data using an encoder module referenced 210 (e.g., video encoder or audio encoder) into the encoded media data referenced 215. Next, server or writer 200 encapsulates the encoded media data into the one or more media files referenced 225, containing the encapsulated media data, using the encapsulation module referenced 220. According to the illustrated example, server or writer 200 comprises at least one encapsulation module 220 to encapsulate the encoded media data. Encoder module 210 may be implemented within server or writer 200 to encode the received media data, or it may be separate from server or writer 200. Encoder module 210 is optional, since server or writer 200 may encapsulate media data previously encoded in a different device or may encapsulate raw media data.

Encapsulation module 220 may generate one media file or a plurality of media files. This media file or plurality of media files correspond to encapsulated media data containing the encapsulation of alternative versions of the media data and/or successive fragments of the encapsulated media data.

Still according to the illustrated embodiment, client or reader 250 is used for processing encapsulated media data for displaying or outputting the media data to a user.

As illustrated, client or reader 250 obtains or receives one or more media files, such as media file 225, via communication network 230 or from storage mean 240. Upon obtaining or receiving the media file, client or reader 250 parses and de-encapsulates the media file to retrieve the encoded media data referenced 265 using a de-encapsulation module referenced 260. Next, client or reader 250 decodes the encoded media data 265 with the decoder module referenced 270 to obtain the media data referenced 275 representing an audio and/or video content (signal) that can be processed by client or reader 250 (e.g., rendered or displayed to a user by dedicated modules not represented). It is noted that decoder module 270 may be implemented within client or reader 250 to decode the encoded media data, or it may be separate from client or reader 250. Decoder module 270 is optional since client or reader 250 may receive a media file corresponding to encapsulated raw media data.

It is noted here that the media file or the plurality of media files, for example media file 225, may be communicated to de-encapsulation module 260 of client or reader 250 in a number of ways. For example, it may be generated in advance by encapsulation module 220 of server or writer 200 and stored as data in a remote storage apparatus in communication network 230 (e.g., on a server or a cloud storage) or a local storage apparatus such as storage means 240 until a user requests a media file encoded therein from the remote or local storage apparatus. Upon requesting a media file, the data is read, communicated, or streamed to de-encapsulation module 260 from the storage apparatus.

Server or writer 200 may also comprise a content providing apparatus for providing or streaming, to a user, content information directed to media files stored in the storage apparatus. For instance, the content information may be described via a manifest file (e.g. a Media Presentation Description (MPD) compliant with the ISO/IEC MPEG-DASH standard, or a HTTP Live Streaming (HLS) manifest) including for example the title of the content and other descriptive metadata and storage location data for identifying, selecting, and requesting the media files. The content providing apparatus may also be adapted for receiving and processing a user request for a media file to be delivered or streamed from the storage apparatus to client or reader 250. Alternatively, server or writer 200 may generate the media file or the plurality of media files using encapsulation module 220 and communicates or streams it directly to client or reader 250 and/or to de-encapsulation module 260 as and when the user requests the content.

The user has access to the audio/video media data (signal) through a user interface of a user terminal comprising client or reader 250 or a user terminal that has means to communicate with client or reader 250. Such a user terminal may be a computer, a mobile phone, a tablet or any other type of device capable of providing/displaying the media data to the user.

For the sake of illustration, the media file or the plurality of media files such as media file 225 represent encapsulated encoded media data (e.g., one or more timed sequences of encoded audio or video data) into boxes according to ISO Base Media File Format (ISOBMFF, ISO/IEC 14496-12 and ISO/IEC 14496-15 standards). The media file or the plurality of media files may correspond to one single media file (prefixed by a FileTypeBox ‘ftyp’ box) or to one initialization segment file (prefixed by a FileTypeBox ‘ftyp’ box) followed by one or more media segment files (possibly prefixed by a SegmentTypeBox ‘styp’ box). According to ISOBMFF, the media file (and segment files when present) may include two kinds of boxes: “media data” boxes (‘mdat’ or ‘imda’) containing the encoded media data and “metadata boxes” (‘moov’ or ‘moof’ or ‘meta’ box hierarchy) containing the metadata defining placement and timing of the encoded media data.

Encoder or decoder modules (referenced respectively 210 and 270 in FIG. 2) encodes and decodes image or video content using an image or video standard. For instance, Image or Video coding/decoding (codecs) standards include ITU-T H.261,

ISO/IEC MPEG-1 Visual, ITU-T H.262 (ISO/IEC MPEG-2 Visual), ITU-T H.263 (ISO/IEC MPEG-4 Visual), ITU-T H.264 (ISO/IEC MPEG-4 AVC), including its scalable video coding (SVC) and multi-view video coding (MVC) extensions, ITU-T H.265 (HEVC), including its scalable (SHVC) and multi-view (MV-HEVC) extensions or ITU-T H.VVC (ISO/IEC MPEG-I Versatile Video Coding (VVC)). The techniques and systems described herein may also be applicable to other coding standards already available or not yet available or developed.

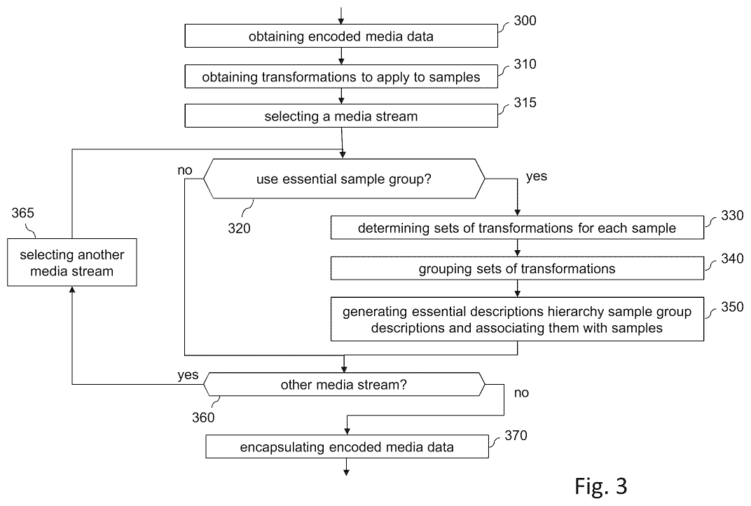

FIG. 3 is a block diagram illustrating an example of steps carried out by a server or writer to encapsulate encoded media data according to some embodiments of the disclosure.

Such steps may be carried out, for example, in the encapsulation module 220 in FIG. 2.

As illustrated, a first step (step 300) is directed to obtaining encoded media data that may be composed of one or more bit-streams representing encoded timed sequences of video, audio, and/or metadata. Potentially, multiple alternatives of the encoded media data may be obtained, for example in terms of quality and resolution. The encoding is optional, the media data may be raw media data.

In a second step (step 310), items of information on transformations to be applied to samples is obtained. These items of information may be obtained from a single source or from several different sources.

A first source of information is the encoded media data. For instance, the encoded media may contain SEI messages that are required for rendering the media data. As another example, the encoded media data may be protected through an encryption scheme. This item of information may be obtained by parsing the encoded media data, for instance to find the SEI messages required for rendering the media data. Possibly, part of the items of information corresponding to a transformation may be signalled by supplemental data obtained at step 300, or through configuration information. For instance, information on the encryption scheme used may be obtained through a configuration file parsed during this second step.

A second source of information is the parameters or settings controlling the encapsulation described by these steps. For instance, the parameters may indicate that one encoded video corresponds to the left view of a stereoscopic video and that another encoded video corresponds to the right view. Possibly, when obtaining information through this second source, the description of a transformation applying to samples of the encoded media data does not require any specific processing of the samples by the encapsulation module. However, the description of the transformation is encapsulated to be transmitted to the decoder or reader. This is the case in the previous example, where the transformation describes that two video streams correspond to a stereoscopic video and their respective locations. Possibly, the description of a transformation obtained through this second source may require some processing of the encoded media data by the encapsulation module. For instance, the transformation may correspond to the protection of part of the encoded media data using an encryption scheme. In this case, the encapsulation module carries out the processing corresponding to the description of the transformation and encapsulate this description, or part of it in the resulting file.

The transformations to be applied to the samples of the encoded media data may vary for the different media streams contained in the encoded media data. For instance, they may be different for a video stream and for an audio stream. In addition, the transformations may vary for the different samples of an encoded stream.

Next, after having obtained the items of information on transformations to be applied to samples, a first media stream from the encoded media data obtained at step 300 is selected (step 315).

Next, it is determined whether the encapsulation should use essential descriptions hierarchy sample groups for describing the selected media stream (step 320).

This determination may be carried out by analysing the transformation to be applied to samples of the selected media stream. This analysis may verify whether there is a sample for which encapsulating the set of transformations applying to it requires using an essential descriptions hierarchy sample group. This may be the case for instance if two transformations in the set are described using essential sample groups. This may also be the case for instance if two transformations in the set are described using a ProtectedSchemeInfoBox or if two transformations in the set are described using a RestrictedSchemeInfoBox. This may also be the case if the knowledge of the ordering of two transformations in the set is necessary for a correct decoding or rendering of the media stream. This may also be the case if there is a transformation that should be applied before decoding the sample, thus requiring to signal that it is applied before the decoding in the essential descriptions hierarchy sample entry associated with the sample.

In an alternative, the analysis may verify if using an essential descriptions hierarchy sample group could help the decoding or rendering of the media stream. A first example of criteria for deciding to use an essential descriptions hierarchy sample group may be that there is a sample onto which a least two different transformations should be applied. In this case, using an essential descriptions hierarchy sample group removes any ambiguity on the application order of these transformations. Another example of criteria may be the presence of a sample for which a least two different transformations, that are not described using a ProtectedSchemeInfoBox, apply. In this case, it is believed that there is no ambiguity on the ordering of the transformation described using a ProtectedSchemeInfoBox, as this transformation should be applied before decoding the sample, but that there may be an ambiguity on the application order of the other transformations.

Possibly, the two alternatives may be combined.

The analysis may be realized by checking for each sample which of the transformations obtained at step 310 apply. This analysis may also be realized by checking how the transformations obtained at step 310 apply to the different samples of the selected media stream. For instance, it may be checked whether a transformation apply to all samples, or to a subset of samples.

In some embodiments, this step may be skipped and the encapsulation may always use an essential descriptions hierarchy sample group. Possibly, this determination may be based on whether some transformations to be applied to the samples of the selected media stream were obtained at step 310.

If an essential sample group is to be used, then the next step is step 330. Otherwise, the next step is step 360.

At step 330, the set of transformations to be applied to each sample of the selected media stream and the order of the transformations are determined. This step may be carried out using the items of information (regarding the transformations to be applied to the samples of the selected media stream) obtained at step 310. For instance, these items of information may indicate to which media stream a transformation apply. They may also indicate whether it applies to all the samples of the media stream or not. If a transformation does not apply to all the samples of the media stream, the items of information may indicate to which samples it applies. Possibly, the application scope of a transformation may be implicit or may be determined through some settings of the encapsulation module.

As an example, a transformation corresponding to the protection of samples may apply to all samples of a media stream, and its application scope may be implicit. As another example, a transformation cropping a video stream may apply only to a range of samples, signalled in the items of information obtained at step 310 regarding this transformation. As yet another example, a transformation corresponding to the application of an SEI message may apply only to samples encoded as intra frames.

Possibly, some transformations may not be included in the sets. For instance, the decoding of the sample may not be included as it is a transformation that is applied to all samples. As another example, the protection removal and decoding of the sample may not be included if they apply to all the samples of the stream as they usually require to be applied before all other transformations.

In a next step (step 340), the set of transformations determined at step 330 are grouped together.

According to a first embodiment, two sets of transformations are grouped together if they are identical. Two sets of transformations may be considered identical if they contain the same list of transformations, in the same order. This advantageously enables to list precisely the transformations applying to each sample of the media stream.

According to a second embodiment, several sets of transformations are grouped together if one set includes the other sets. This means that all the transformations in the set of transformations contained in an included set are also present in the list of transformations of the including set, in the same order.

According to a third embodiment, several sets of transformations are grouped together if the ordering of their transformations are compatible. The transformation orders of sets of transformations are considered as incompatible if the transformations are the same but the transformation orders are different.

The second and third embodiment advantageously combine several sets of transformations into a single description, decreasing the signalling cost of these transformations and their ordering.

Possibly, the second and third embodiment may be combined. For instance, sets of transformations may be grouped together if one set includes the other sets and when this is not the case, sets of transformations may be grouped together if they are compatible.

According to a fourth embodiment, different ways of grouping sets of transformations are compared, for example as a function of their signalling cost. These groupings may comprise one or more among those described in the first embodiment, those described in the second embodiment, those described in the third embodiment, and those resulting from combining the second and third embodiments. Decreasing the number of groups decreases the signalling cost. However, decreasing the number of groups also decreases the accuracy of the signalling of the transformations to be applied to different samples. Therefore, as a trade-off between these two aspects, each grouping may be associated with a cost taking into account the number of groups and the signalling cost, such that increasing the number of groups decreases the cost and increasing the signalling cost increases the cost. For instance, a weighted sum may be used, with a negative weight for the number of groups and a positive weight for the signalling cost. The grouping with the lowest cost is preferably the one selected for the following steps.

Using the first embodiment implies that all the transformations listed in an essential descriptions hierarchy sample group (‘esgh’) description associated with a sample applies to the sample. Using the second or third embodiment implies that some transformations listed in an essential descriptions hierarchy sample group (‘esgh’) description associated with a sample may not apply to the sample.

Possibly, the choice of the embodiment to use for grouping sets of transformations may be controlled by external settings. For instance, in some environments, the server or writer may be configured to use only the first embodiment. As another example, the specification of the essential descriptions hierarchy sample group may enforce the usage of the first embodiment.

Possibly, the choice of the embodiment may be signalled by the server or writer. In particular, whether the server or writer used only the first embodiment or used other embodiments may be signalled. For instance, a file type, a brand, a profile, or any other high-level description of the format of the media file may indicate that the first embodiment is used in the media file. As another example, different versions of the essential descriptions hierarchy sample group, identified with different grouping_type values, may be used to signal the embodiment used. As another example, the essential descriptions hierarchy sample group description entry may be modified as follows to include an indication of which embodiment was used:

```
class EssentialDescriptionsHierarchyEntry ( )
  extends SampleGroupDescriptionEntry (‘esgh’)
{
  unsigned int(1) strict_mapping;
  unsigned int(7) reserved;
  unsigned int(32) num_groupings;
  unsigned int(32) sample_group_description_type[num_groupings];
}
```

The field strict_mapping is set to the value 1 when only the first embodiment is used. Otherwise, if another embodiment is used, the field value is 0.

It is noted that in the current ISOBMFF specification, the definition of the essential descriptions hierarchy sample group (10.12.1) lists the possible values contained in the sample_group_description_type field. In particular, it states that the value ‘cenc’ indicates the position of the decryption in the transformation chain. However, the text should specify where the CENC information is to be found. In addition, this information is defined as protection (and not decryption) in 8.12. In some embodiments of the inventions, the value ‘cenc’ may indicate the position of the content protection removal in the transformation chain. The content protection removal information is provided by the ProtectionSchemeInfoBox that shall be present in the protected sample entry associated with the sample mapped to this sample group.

In addition, the list of possible values contained in the sample_group_description_type field includes any scheme_type value contained in the SchemeTypeBox of the RestrictedSchemeInfoBox of the track that contains this sample group; this indicates the position of the respective restricted media transformation in the transformation chain. This is not in accordance with the remaining of the ISOBMFF specification as the container of a RestrictedSchemeInfoBox is not the track but the restricted sample entry associated with the mapped sample. To be in accordance with the definition of the RestrictedSchemeInfoBox, in some embodiments of the invention, the sample_group_description_type field may contain any scheme_type value contained in the SchemeTypeBox of the RestrictedSchemeInfoBox of the restricted sample entry associated with sample(s) mapped to this sample group; this indicates the position of the respective restricted media transformation in the transformation chain.

Last, the list of possible values contained in the sample_group_description_type field does not include the grouping_type of essential sample groups. Following some embodiments of the invention, the definition of the sample_group_description_type field may state that the possible values of this field include any grouping_type of an essential sample group description describing a sample processing applying to a sample mapped to this sample group description entry; this indicates the position of the corresponding transformation in the transformation chain.

Turning back to FIG. 3 and after having grouped the sets of transformations to be applied to the different samples, for each group, an essential descriptions hierarchy sample group description entry is generated to list all the transformations comprised in the group, in their application order (step 350). In addition, for each group, a restricted sample entry, containing a RestrictedSchemeInfoBox with a scheme_type equal to ‘essg’, is also generated, describing any transformation of the group that is signalled using a ProtectedSchemeInfoBox or using a RestrictedSchemeInfoBox. Last, for each group, for each transformation signalled using a sample group, a sample group description entry is generated to describe this transformation.

In some embodiments, similar restricted sample entry or similar sample group description entries may be shared by different groups.

In some embodiments, the decoding of the sample is not listed in the essential descriptions hierarchy sample group description entry as it is necessary for all samples. In some embodiments, one or more transformations may not be listed in the essential descriptions hierarchy sample group description entry when their ordering has no ambiguity.

When generating a restricted sample entry a containing RestrictedSchemeInfoBox with a scheme_type equal to ‘essg’, other transformations described using a restricted sample entry may be described inside the generated restricted sample entry.

According to a first embodiment for generating an essential descriptions hierarchy sample group, a restricted sample entry is created, containing a first RestrictedSchemeInfoBox (‘rinf’) box with a scheme type equal to ‘essg’. This RestrictedSchemeInfoBox box contains an OriginalFormatBox (‘frma’) box indicating the original four-character code of the sample entry and a SchemeTypeBox (‘schm’) box indicating that the transformation applied has a scheme_type equal to ‘essg’. The restricted sample entry may contain other RestrictedSchemeInfoBox (‘rinf’) boxes for describing the other transformations described using a restricted sample entry (e.g., stereovision, sample packing or projection for omnidirectional video). Preferably, these RestrictedSchemeInfoBox boxes appear in the order corresponding to the application of the transformation they describe, this order being signalled within the essential descriptions hierarchy sample group. Preferably, the RestrictedSchemeInfoBox with the scheme_type equal to ‘essg’ occurs first in the restricted sample entry. Preferably, the other RestrictedSchemeInfoBox, describing other sample entry transformations do not contain an OriginalFormatBox (‘frma’) box indicating the original four-character code of the sample entry, to avoid redundancy in the description of the samples. Possibly, the other RestrictedSchemeInfoBox may contain an OriginalFormatBox indicating the original four-character code of the sample entry, to not break parsing of this RestrictedSchemeInfofBox. Possibly, a RestrictedSchemeInfoBox may contain an OriginalFormatBox indicating the four-character code of the previous transformation applied to the sample entry during the encoding or encapsulation of the media and described using either a RestrictedSchemeInfoBox or a ProtectedSchemeInfoBox. In this last case, the RestrictedSchemeInfoBox box with a scheme_type equal to ‘essg’ may contain an OriginalFormatBox indicating the four-character code of the last transformation applied to the sample entry before the transformation corresponding to the ‘essg’ scheme_type itself. In this way, the sample entry transformations are chained from the original sample entry to the ‘essg’ transformation through the four-character codes indicated in their OriginalFormatBox. Preferably, the other RestrictedSchemeInfoBox contain a SchemeTypeBox and possibly a SchemeInformationBox describing the transformation applied. Possibly, the other RestrictedSchemeInfoBox may contain one or more other boxes, such as for example a CompatibleScheme TypeBox (‘csch’).

Possibly, the restricted sample entry may also contain one or more ProtectionSchemeInfoBox (‘sinf’) describing sample entry transformations applying protection schemes to samples. The content of these ProtectionSchemeInfoBox may be handled as described above for the content of the other RestrictedSchemeInfoBox.

Possibly, the number of RestrictedSchemeInfoBox contained in the sample entry may be limited to two, one corresponding to the ‘essg’ scheme_type, the other corresponding to the scheme_type of the original sample entry transformation. This is closer to the current usage of RestrictedSchemeInfoBox where at most one such box is allowed in a sample entry.

Possibly, in this first embodiment, there is a single RestrictedSchemeInfoBox inside the sample entry, corresponding to the ‘essg’ scheme_type. Other sample entry transformations that are defined as being described using a RestrictedSchemeInfoBox are instead described using a different box, for example an AdditionalRestrictedSchemeInfoBox with the four-character code ‘ainf’. This AdditionalRestrictedSchemeInfoBox may contain an OriginalFormatBox, a SchemeTypeBox and/or a SchemeInformationBox.

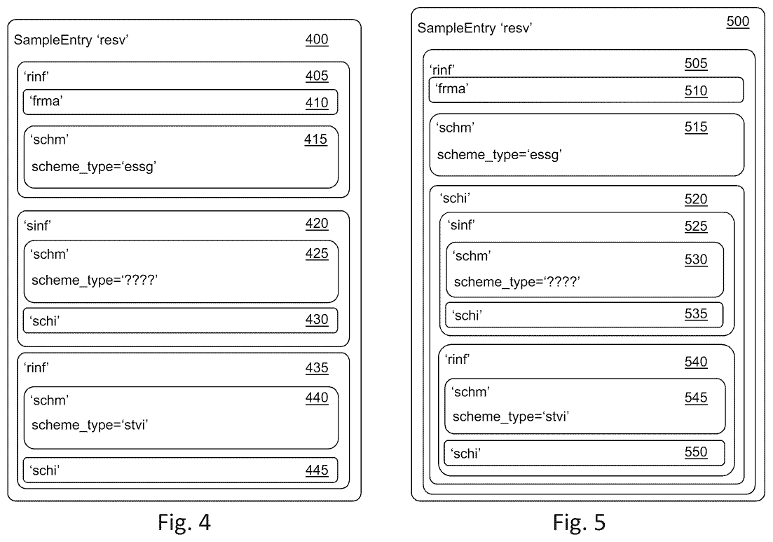

This first embodiment is illustrated by FIG. 4. The outer box referenced 400 corresponds to a restricted sample entry, with the format ‘resv’. This sample entry contains a first RestrictedSchemeInfoBox (‘rinf’), referenced 405, with the scheme_type ‘essg’. This RestrictedSchemeInfo box contains an OriginalFormatBox (‘frma’), referenced 410, signalling the original format of the sample mapped to this sample entry, and a SchemeTypeBox (‘schm’), referenced 415, identifying the transformation with the scheme_type ‘essg’. As illustrated, the sample entry further contains a

ProtectionSchemeInfoBox (‘sinf’), referenced 420, occurring after the first RestrictedSchemeInfoBox. This ProtectionSchemeInfoBox describes a protection sample entry transformation. It does not contain any OriginalFormatBox, but contains a SchemeTypeBox 425 and a SchemeInformationBox 430. The third box in the sample entry is a RestrictedSchemeInfoBox (‘rinf’), referenced 435, corresponding to a stereovision transformation. This RestrictedSchemeInfoBox does not contain any OriginalFormatBox however, it contains a SchemeTypeBox 440 with a scheme_type equal to ‘stvi’ and a SchemeInformationBox 445 further describing the parameters of the stereovision for the samples mapped in this sample entry.

Turning back to FIG. 3 and according to a second embodiment for generating an essential descriptions hierarchy sample group, a restricted sample entry is created, containing a single RestrictedSchemeInfoBox (‘rinf’) box with a scheme_type equal to ‘essg’. This RestrictedSchemeInfoBox box contains an OriginalFormatBox (‘frma’) box indicating the original four-character code of the sample entry and a SchemeTypeBox (‘schm’) box indicating that the transformation applied has a scheme_type equal to ‘essg’. The RestrictedSchemeInfoBox may contain a SchemeInformationBox. In turn, this SchemeInformationBox may contain RestrictedSchemeInfoBox (‘rinf’) boxes for describing the other transformations described using a RestrictedSchemeInfoBox. These other transformations correspond to transformations that are not described through an essential sample group but rather using restricted media tracks according to ISOBMFF. Preferably, these

RestrictedSchemeInfoBox boxes appear in the order corresponding to the application of the transformations they describe, this order being signalled within the essential descriptions hierarchy sample group. Preferably, the RestrictedSchemeInfoBox boxes contained in the SchemeInformationBox do not contain an OriginalFormatBox (‘frma’) box indicating the original four-character code of the sample entry, in order to avoid redundancy in the description of the sample entry. Possibly, the RestrictedSchemeInfoBox boxes contained in the SchemeInformationBox may contain an OriginalFormatBox indicating the original four-character code of the sample entry, to keep the parsing of a RestrictedSchemeInfoBox unchanged whatever its position in the box structure within a restricted sample entry. Possibly, the RestrictedSchemeInfoBox boxes contained in the SchemeInformationBox may contain an OriginalFormatBox indicating the four-character code of the previous transformation applied to the sample entry during the encoding or the encapsulation of the media. In this last case, the RestrictedSchemeInfoBox box with the scheme_type equal to ‘essg’ may contain an OriginalFormatBox indicating the four-character code of the last transformation applied to sample entry during the encoding or the encapsulation of the media before the transformation corresponding to the ‘essg’ scheme_type itself. In this way, the sample entry transformations are chained from the original sample entry to the ‘essg’ transformation through the four-character codes indicated in their OriginalFormatBox. Preferably, the RestrictedSchemeInfoBox boxes contained in the SchemeInformationBox contain a Scheme TypeBox and possibly a SchemeInformationBox describing the transformation to be applied. Possibly, the RestrictedSchemeInfoBox boxes contained in the SchemeInformationBox may contain one or more other boxes, such as for example a CompatibleScheme TypeBox (‘csch’).

Possibly, the restricted sample entry may contain one or more ProtectionSchemeInfoBox (‘sinf’) describing sample entry transformations applying protection schemes to samples. The content of these ProtectionSchemeInfoBox may be handled as described above for the content of the other RestrictedSchemeInfoBox. Alternatively, the SchemeInformationBox corresponding to the scheme type ‘essg’ may contain one or more ProtectionSchemeInfoBox (‘sinf’) describing sample entry transformations applying protection schemes to samples. The content of these ProtectionSchemeInfoBox may be handled as described above for the content of the other RestrictedSchemeInfoBox.

In a variant of this embodiment, the description of a restricted sample entry transformation within the SchemeInformationBox may be contained in a different box, for instance an AdditionalRestrictedSchemeInfoBox with the four-character code ‘ainf’. This AdditionalRestrictedSchemeInfoBox may have the same structure the as RestrictedSchemeInfoBox. This allows keeping the definition of the RestrictedSchemeInfoBox unchanged. Similarly, the description of a protected sample entry transformation within the SchemeInformationBox may be contained in a different box, for instance an AdditionalProtectionSchemeInfoBox with the four-character code pinf. This AdditionalProtectionSchemeInfoBox may have the same structure as the ProtectionSchemeInfoBox,

This second embodiment advantageously enables applying several restricted sample transformations to a single sample. It provides a better backward compatibility than the first embodiment with existing implementation of the ISOBMFF specification, by keeping the constraint of using at most one RestrictedSchemeInfoBox within a sample entry.

The current specification of ISOBMFF states in the definition of the essential descriptions hierarchy sample group (10.12.1) that samples associated with essential sample groups shall use a restricted sample entry indicating the original media type (e.g., ‘resv’, ‘resa’) with a scheme_type equal to ‘essg’. It however does not say what the original format should be set to in this transformation. This can be inferred by the specification text of ‘resv’, but could lead to ambiguities when content protection or other restricted transformation are also present In some embodiments of the invention the original sample entry type (without any content protection or restricted transformation) is stored within an OriginalFormatBox contained in the RestrictedSchemeInfoBox.

The original design of essential descriptions hierarchy sample groups was not using restricted schemes, but the it was felt it would be safer to transform the sample entry type into a restricted sample entry whenever essential sample groups are present. However, in doing so, the re-design broke compatibility with the usage of existing restricted schemes. Indeed, there can be only one instance of RestrictedSchemeInfoBox in a restricted sample entry. This entry is now used to indicate the ‘essg’ scheme type. As a consequence, no other transformation relying on the RestrictedSchemeInfoBox can be used jointly with an essential sample group. It can be noted that sample entry transformations cannot be nested in ISOBMFF: a restricted sample entry such as ‘resv’ or ‘resa’ can only describe a single transformation. Since the essential descriptions hierarchy sample group ‘esgh’ is designed to describe multiple essential groupings that may require a transformation of the sample data, it would seem natural to allow describing existing restricted transformations jointly with essential sample groups, following the order given in ‘esgh’. To avoid any potential backward compatibility of signaling multiple RestrictedSchemeInfoBox in a sample entry, in some embodiments of the invention, a restricted sample entry may be structured as follow:
a single RestrictedSchemeInfoBox (with a scheme_type equal to ‘essg’) is contained inside the restricted sample entry;
for the ‘essg’ transformation, the payload of the SchemeInformationBox consists of zero or more RestrictedSchemeInfoBox containing no OriginalFormatBox, with at most one occurrence of a given scheme type,
the payload of the SchemeInformationBox of the ‘essg’ transformation shall not contain a RestrictedSchemeInfoBox with scheme_type equal to ‘essg’.

In other words, for a restricted sample entry with a scheme_type equal to ‘essg’, the following applies:
the restricted sample entry shall contain a single

RestrictedSchemeInfoBox (with a scheme_type equal to ‘essg’);
the payload of the SchemeInformationBox consists of zero or more RestrictedSchemeInfoBox containing no OriginalFormatBox, with at most one occurrence of a given scheme_type;
the payload of the SchemeInformationBox of the ‘essg’ transformation shall not contain a RestrictedSchemeInfoBox with scheme_type equal to ‘essg’.

This allows multiple restricted schemes to be used jointly with essential grouping.

In some of these embodiments, the list of possible values contained in the sample_group_description_type field includes Any scheme_type value contained in the SchemeTypeBox of a RestrictedSchemeInfoBox contained in the SchemeInformationBox of a RestrictedSchemeInfoBox with the scheme_type ‘essg’ of the restricted sample entry associated with sample(s) mapped to this sample group; this indicates the position of the corresponding restricted media transformation in the transformation chain.

This second embodiment is illustrated by FIG. 5. The outer box corresponds to a restricted sample entry, with the format ‘resv’, referenced 500. This sample entry contains a single RestrictedSchemeInfoBox (‘rinf’), referenced 505, corresponding to a scheme_type equal to ‘essg’. This RestrictedSchemeInfo box contains an OriginalFormatBox (‘frma’), referenced 510, signalling the original four-character code of the untransformed sample entry, a SchemeTypeBox (‘schm’), referenced 515, identifying the transformation of the sample entry with the scheme_type ‘essg’, and a SchemeInformationBox (‘schi’), referenced 520. The SchemeInformationBox contains a ProtectionSchemeInfoBox (‘sinf’), referenced 525.

This ProtectionSchemeInfoBox describes a protection sample entry transformation. It does not contain any OriginalFormatBox, but contains a SchemeTypeBox 530 and a SchemeInformationBox 535. The SchemeInformationBox 520 also contains a RestrictedSchemeInfoBox (‘rinf’), referenced 540, corresponding (for the sake of illustration, to a stereovision transformation. This RestrictedSchemeInfoBox does not contain any OriginalFormatBox. It contains a SchemeTypeBox 545 with a scheme_type equal to ‘stvi’ and a SchemeInformationBox 550.

Turning back to FIG. 3 and according to some embodiments, the steps 310, 320, 330, 340, and/or 350 may be carried out in a different order, or may be combined, fully or partially. For instance, step 330 and 340 may be combined into a single step, where the set of transformations applying to a sample is determined and then grouped with the sets of transformations previously determined. As another example, all these steps may be combined together. First, the transformations to be applied to samples of media data are obtained, as well as their order. These transformations are organized into a single ordered set and this set is used for generating the essential descriptions hierarchy sample group description entry associated with the samples. Possibly, some samples may not be associated with this essential descriptions hierarchy sample group description entry.

Next, or if the encapsulation should not use an essential descriptions hierarchy sample group for describing the selected media stream (step 320), it is checked whether there is any other media stream to process within the media data obtained at step 300 (step 360). If this is the case, another media stream is selected (step 365) and the algorithm loops on step 320.

If this is not the case, the encoded media data are encapsulated using the essential descriptions hierarchy sample group description entries and the restricted sample entries generated at step 350 if essential descriptions hierarchy sample groups should be used.

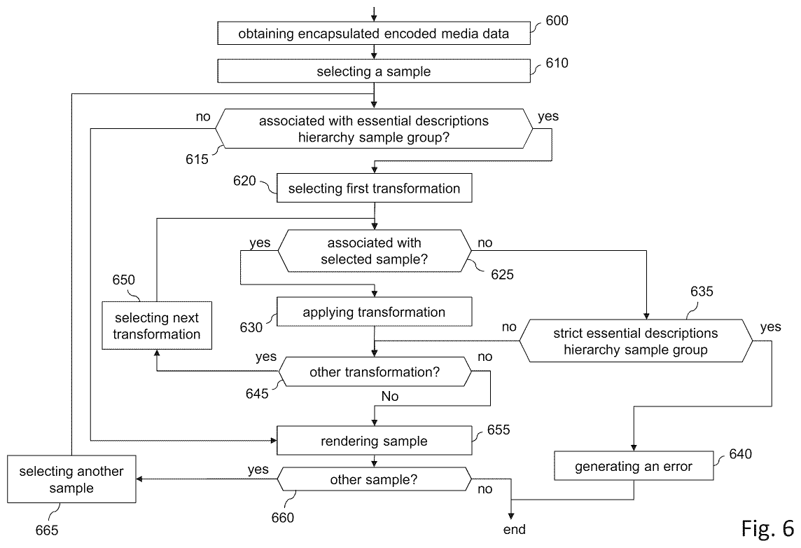

FIG. 6 is a block diagram illustrating an example of steps carried out by a client or reader to process encapsulated media data according to some embodiments of the disclosure.

As illustrated, a first step is directed to obtaining an encapsulated encoded media data (step 600). Next, a first sample of a media stream encapsulated in the obtained encapsulated encoded media data is selected (step 610).

Next, it is checked whether the selected sample is associated with an essential descriptions hierarchy sample group description entry (step 615). If the selected sample is not associated with an essential descriptions hierarchy sample group description entry, the selected sample is rendered (step 655).

On the contrary, if the selected sample is associated with an essential descriptions hierarchy sample group description entry, the next step is step 620. In this step, the first transformation listed in the essential descriptions hierarchy sample group description entry associated with the sample is selected.

Possibly, the list of transformations signalled in the essential descriptions hierarchy sample group description entry associated with the sample may be completed before selecting the first transformation. For instance, if the decoding process is not listed in the essential descriptions hierarchy sample group description entry associated with the sample, the decoding process is added to the list before any other transformation. As another example, one or several transformations may be inserted at the beginning of the list of transformations signalled by the essential descriptions hierarchy sample group description entry associated with the sample. If the sample is protected, the client or reader may insert as a first transformation the removal of the protection and as a second transformation the decoding of the sample.

In some embodiments, if there is a transformation to be applied to the selected sample, that is not listed in the essential descriptions hierarchy sample group description entry associated with the sample, the media data are considered as not correct and the client or reader generates an error (step 640). Such a transformation may be described by an essential sample group associated with the sample, by a RestrictedSchemeInfoBox contained in the sample entry associated with the sample, or by a ProtectedSchemeInfoBox contained in the sample entry associated with the sample.

In some embodiments, if there is a transformation to be applied to the selected sample (e.g., the sample is mapped to an essential sample group) that is not listed in the essential descriptions hierarchy sample group description entry associated with the sample, it is checked whether this transformation may be applied at any point during the processing or rendering of the sample. If this is the case, the transformation may be added at a predefined position in the list, for instance at the end of the list, or may be processed independently of the transformations comprised in the list. If this is not the case, the media data are considered as not correct and the client or reader generates an error (step 640). For instance, media data targeting stereovision may include an essential sample group indicating that a stream corresponds to the left view of the stereovision. This sample group is indicated as essential to enforce that the reader understands it for correctly rendering the media in stereovision. However, the processing associated with the stereovision is independent from the other processing for rendering the selected sample as it only requires that the rendering is realized on the display corresponding to the left view.

In some embodiments, if there is a transformation to be applied to the selected sample that is not listed in the essential descriptions hierarchy sample group description entry associated with the sample, this transformation is added to the list at a predefined position. This predefined position may depend on the transformation. For instance, removing the protection may be inserted in the first position of the list, prior to the decoding. The decoding may be inserted after any protection removal and before any other transformation. Other transformations may be added at the end of the list.

Next, at step 625, it is checked whether this selected transformation is associated with the selected sample. If the selected transformation corresponds to the grouping_type of an essential sample group, it may be checked whether the sample is associated with a sample group description entry with this grouping_type. If the selected transformation corresponds to the decoding process, the check result is always positive. If the selected transformation corresponds to a protection removal, the transformation being identified with the four-character code ‘cenc’, it is checked whether the selected sample is associated with a sample entry that contains the description of the protection scheme. This is the case if a ProtectionSchemeInfoBox is present within the sample entry corresponding to the sample. In some embodiments of the disclosure, the ProtectionSchemeInfoBox may be contained directly in the sample entry box. In some embodiments, the ProtectionSchemeInfoBox may be contained in another box, for instance a SchemeInformationBox, itself contained directly or not in the sample entry box. In some embodiments, the description of the protection scheme may be contained in a different box, for example an AdditionalProtectionSchemeInfoBox. If the selected transformation corresponds to a processing associated with a restricted sample entry, the transformation being identified with the four-character code corresponding to its scheme_type value, then it is checked whether the selected sample is associated with a sample entry that contains the description of this transformation. This is the case if a RestrictedSchemeInfoBox containing a SchemeTypeBox with a scheme_type having the value identifying the transformation is present within the sample entry. In some embodiments of the disclosure, this RestrictedSchemeInfoBox may be contained directly in the sample entry corresponding to the sample. In some embodiments, this RestrictedSchemeInfoBox may be contained in another box, for instance a SchemeInformationBox, itself contained directly or not in the sample entry box. In some embodiments, the description of the protection scheme may be contained in a different box, for example an AdditionalRestrictedSchemeInfoBox.

If the selected transformation is associated with the selected sample, the transformation is applied to the selected sample (step 630). Applying the transformation to the sample may use the description of the transformation contained in a sample group description entry, in a ProtectionSchemeInfoBox, or in a RestrictedSchemeInfoBox. The next step is step 645.

If the selected transformation is not associated with the selected sample, it is checked whether the essential descriptions hierarchy sample group description entry associated with the selected sample is restricted to list only transformations associated with the sample or if it is allowed to list other transformations (step 635).

In some embodiments, external settings may specify whether a sample has to be associated with all the transformations listed in the essential descriptions hierarchy sample group description entry associated with it or not. For instance, in some environments, the client or reader may be configured such that any transformation listed in an essential descriptions hierarchy sample group description entry associated with a sample applies to the sample. As another example, the specification of the essential descriptions hierarchy sample group may enforce that any transformation listed in an essential descriptions hierarchy sample group description entry associated with a sample applies to the sample.

In some embodiments, the signalling in the media file may specify whether a sample has to be associated with all the transformations listed in the essential descriptions hierarchy sample group description entry associated with it or not. This signalling may be done using a file type, a brand, a profile, or any other high-level description of the format of the media file. Different versions of the essential descriptions hierarchy sample group, possibly identified with different grouping_types, may be used for this signalling. A modified version of the essential descriptions hierarchy sample group description entry, such as the one listed herein above, may be used for this signalling.

If the essential descriptions hierarchy sample group description entry associated with the sample is allowed to list transformations not associated with the selected sample, then the next step is step 645.

Otherwise, if the essential descriptions hierarchy sample group description entry associated with the sample is restricted to list only transformations associated with the selected sample, the next step is step 640 wherein an error is generated. Indeed, there is a transformation listed in the essential descriptions hierarchy sample group description entry associated with the sample that does not apply to the sample, while this is required. Therefore, the media file is not correct. Some actions may be carried out to inform the user of this error.

At step 645, it is checked whether there are any remaining transformations in the list of the essential descriptions hierarchy sample group description entry associated with the selected sample. If at least one transformation is remaining in the list, the next transformation in the list is selected (step 650) and the algorithm loops on step 625.

On the contrary, if all the transformations of the list have been processed, the sample is rendered (step 655).

Next, it is checked whether there are any remaining samples in the media stream (step 660). If this is the case, another sample is selected (step 665) and the algorithm loops on step 615.

In some embodiments, applying transformations to the selected sample at step 630 and rendering the selected sample at step 660 may be deferred or delayed. For instance, the client or reader may process the media file to ensure it is correct without rendering it. As another example, the client or reader may pre-process in advance some samples of a media stream and only transform and render each sample at the time when it should be displayed to the user.

Steps 610 to 665 may be realized for several media streams contained in a media file either in parallel, or sequentially, or in an interleaved way.

The current ISOBMFF specification does not indicate whether a sample mapped to a given esgh sample group description entry shall be mapped to all essential sample group types listed in the sample_group_description_type field. In the first embodiment described above, the specification may enforce such a mapping, however this could imply changing the esgh whenever an essential sample group (listed in esgh entry) is not mapped to the sample mapped to the esgh entry. Given that esgh is only here to describe the transformation order and not which transformations apply (given by cenc, rinf or other essential sample groups), not enforcing this rule would allow for more static esgh descriptions, so simpler authoring/processing. Therefore, in some preferred embodiments of the invention, when a sample mapped to an essential descriptions hierarchy sample group entry, with sample_group_description_type [SG1. . . . SGN], is not mapped to a sample group description with grouping_type SGi or doesn't contain a ProtectionSchemeInfoBox or a RestrictedSchemeInfoBox with a scheme_type equal to SGi, the processing described by SGi is ignored for this sample.

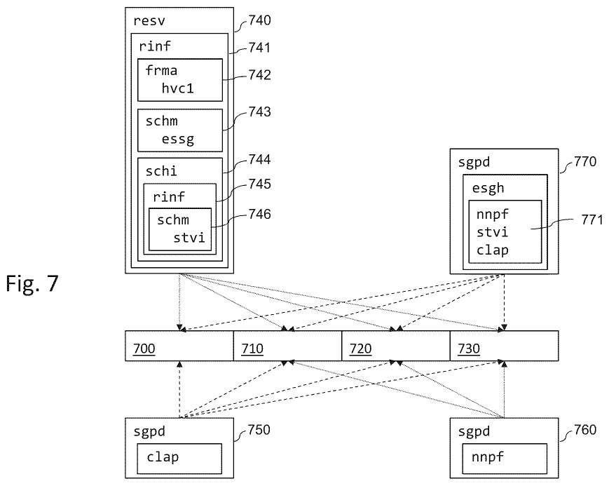

FIG. 7 illustrates a media stream encapsulated using some embodiments of the disclosure. This media stream comprises four samples referenced 700, 710, 720, and 730. These samples are described by the sample entry 740. This sample entry is a restricted sample entry with the four-character code ‘resv’. The sample entry contains a RestrictedSchemeInfoBox ‘rinf’ 741 that, in turn, contains an OriginalFormatBox ‘frma’ 742 that indicates the original format of the untransformed sample entry, for example ‘hvc1’, a SchemeTypeBox ‘schm’ 743, indicating the scheme_type of the restricted sample entry, ‘essg’, and a SchemeInformationBox ‘schi’ 744 describing the content of the samples. This SchemeInformationBox contains another RestrictedSchemeInfoBox ‘rinf’ 745 indicating that the samples correspond to a stereovision media. This RestrictedSchemeInfoBox contains a Scheme TypeBox 746 with a scheme_type of ‘stvi’.

The four samples 700, 710, 720, and 730 are associated with a SampleGroupDescriptionEntry contained in a SampleGroupDescriptionBox ‘sgpd’ 750. This SampleGroupDescriptionEntry has a grouping_type equal to ‘clap’, signalling that a cropping transformation is to be applied before rendering the samples. In addition, the three samples 710, 720, and 730 are associated with another SampleGroupDescriptionEntry with a grouping_type ‘nnpf’ contained in a SampleGroupDescriptionBox ‘sgpd’ 760. This SampleGroupDescriptionEntry signals that a neural-network post-filter operation is to be applied to the samples, for instance to improve the quality of the decoded samples.

As a result, there are two transformations to apply to the decoded sample 700 before rendering it: the crop signalled in the SampleGroupDescriptionBox 750 and the stereovision signalled in the RestrictedSchemeInfoBox 745 with the scheme_type ‘stvi’. For the decoded samples 710, 720 and 730, there are three transformations to apply before rendering them: the crop, the stereovision and the neural-network post-filter signalled in the SampleGroupDescriptionBox 760. The ordering of these transformations is described in a SampleGroupDescriptionEntry with a grouping_type ‘esgh’ contained in a SampleGroupDescriptionBox ‘sgpd’ 770. This SampleGroupDescriptionEntry 771 lists the transformations in their application order: first the neural-network post-filter onto decoded samples, then the stereovision on post-filtered samples and last the crop on stereo images.

According to this example and considering sample 700 that is not associated with a SampleGroupDescriptionEntry with the grouping_type ‘nnpf’, the neural network post-filter transformation is ignored in the list signalled the by SampleGroupDescriptionEntry with the grouping_type ‘esgh’. In addition, for all the samples, the ordering of the decoding among all the transformations to be applied to each sample is implicit (since ‘stsd’ is not listed in the ‘esgh’ sample group description entry 771) and is carried out before any other processing.

In a preferred embodiment of the invention, the essential descriptions hierarchy sample grouping may be defined as follows.

When an essential sample group (i.e., a sample group for which the version of the SampleGroupDescriptionBox is equal to 3), which describes essential information for the associated samples, is used, parsers can only attempt to process tracks for which there are no unrecognized sample group descriptions marked as essential.

The essential descriptions hierarchy sample group (‘esgh’) indicates the processing order of the essential sample group descriptions applying to a given sample. This sample group description is an essential sample group description and shall use version 3 of the SampleGroupDescriptionBox. It shall be present if at least one essential sample group description with grouping_type other than ‘esgh’ is present.

Each essential sample group description, except the essential descriptions hierarchy sample group itself, shall be listed in the EssentialDescriptionsHierarchyEntry.

The grouping_type_parameter for an essential descriptions hierarchy sample group description is not defined, and its value shall be set to 0.

The syntax of EssentialDescriptionsHierarchyEntry is the same for all media types.

Samples associated with essential sample groups shall use a restricted sample entry indicating the original media type (e.g. ‘resv’, ‘resa’) with a scheme_type equal to ‘essg’. The original sample entry type (without any content protection or restricted transformation) is stored within an OriginalFormatBox contained in the RestrictedSchemeInfoBox.

For a restricted sample entry with a scheme_type equal to ‘essg’, the following applies:

The restricted sample entry shall contain a single RestrictedSchemeInfoBox (with a scheme_type equal to ‘essg’).

The payload of the SchemeInformationBox consists of zero or more RestrictedSchemeInfoBox containing no OriginalFormatBox, with at most one occurrence of a given scheme_type.

The payload of the SchemeInformationBox of the ‘essg’ transformation shall not contain a RestrictedSchemeInfoBox with scheme_type equal to ‘essg’.

The transformations given in sample_group_description_type are listed in the order in which a file reader shall apply each transformation: any sample processing described by a sample group of type sample_group_description_type [i] shall be applied before any sample processing described by a sample group of type sample_group_description_type [i+1].

When a sample mapped to an essential descriptions hierarchy sample group entry, with sample_group_description_type [SG₁. . . . SG_{N}], is not mapped to a sample group description with grouping_type SGᵢ or doesn't contain a ProtectionSchemeInfoBox or a RestrictedSchemeInfoBox with a scheme_type equal to SGᵢ, the processing described by SGᵢ is ignored for this sample.

In the sample_group_description_type list, the following transformation values are allowed:

‘stsd’: indicates the position of the decoding process in the transformation chain.

‘cenc’: indicates the position of the content protection removal in the transformation chain. The content protection removal information is provided by the ProtectionSchemeInfoBox that shall be present in the protected sample entry associated with the sample mapped to this sample group.

Any scheme_type value contained in the SchemeTypeBox of a RestrictedSchemeInfoBox contained in the SchemeInformationBox of a RestrictedSchemeInfoBox with the scheme_type ‘essg’ of the restricted sample entry associated with sample(s) mapped to this sample group; this indicates the position of the corresponding restricted media transformation in the transformation chain.

Any grouping_type of an essential sample group description describing a sample processing applying to a sample mapped to this sample group description entry; this indicates the position of the corresponding transformation in the transformation chain.

If ‘stsd’ is absent from the list of sample_group_description_type, all listed transformations shall apply to decoded samples. If ‘cenc’ is present in the list, ‘stsd’ shall be present.

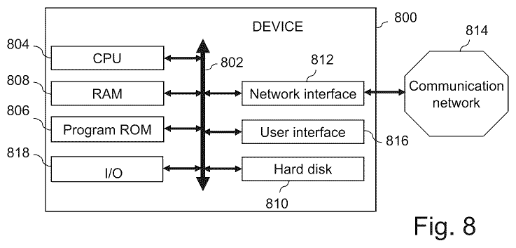

FIG. 8 is a schematic block diagram of a computing device 800 for implementation of one or more embodiments of the disclosure. The computing device 800 may be a device such as a micro-computer, a workstation, or a light portable device. The computing device 800 comprises a communication bus 802 connected to:
a central processing unit (CPU) 804, such as a microprocessor;
a random access memory (RAM) 808 for storing the executable code of the method of embodiments of the disclosure as well as the registers adapted to record variables and parameters necessary for implementing the method for encapsulating, indexing, de-encapsulating, and/or accessing data, the memory capacity thereof can be expanded by an optional RAM connected to an expansion port for example;
a read only memory (ROM) 806 for storing computer programs for implementing embodiments of the disclosure;
a network interface 812 that is, in turn, typically connected to a communication network 814 over which digital data to be processed are transmitted or received. The network interface 812 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 804;
a user interface (UI) 816 for receiving inputs from a user or to display information to a user;
a hard disk (HD) 810; and/or
an I/O module 818 for receiving/sending data from/to external devices such as a video source or display.

The executable code may be stored either in read only memory 806, on the hard disk 810 or on a removable digital medium for example such as a disk. According to a variant, the executable code of the programs can be received by means of a communication network, via the network interface 812, in order to be stored in one of the storage means of the communication device 800, such as the hard disk 810, before being executed.

The central processing unit 804 is adapted to control and direct the execution of the instructions or portions of software code of the program or programs according to embodiments of the disclosure, which instructions are stored in one of the aforementioned storage means. After powering on, the CPU 804 is capable of executing instructions from main RAM memory 808 relating to a software application after those instructions have been loaded from the program ROM 806 or the hard-disc (HD) 810 for example. Such a software application, when executed by the CPU 804, causes the steps of the flowcharts shown in the previous figures to be performed.

In this embodiment, the apparatus is a programmable apparatus which uses software to implement the disclosure. However, alternatively, the present disclosure may be implemented in hardware (for example, in the form of an Application Specific Integrated Circuit or ASIC).

Although the present disclosure has been described herein above with reference to specific embodiments, the present disclosure is not limited to the specific embodiments, and modifications will be apparent to a person skilled in the art which lie within the scope of the present disclosure.

Many further modifications and variations will suggest themselves to those versed in the art upon making reference to the foregoing illustrative embodiments, which are given by way of example only and which are not intended to limit the scope of the disclosure, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encapsulating media data, by a processing device, the method comprising:
generating a track comprising a sample of the media data and descriptive metadata, the descriptive metadata comprising:
an indication that the track is restricted, and
a first restricted scheme description data structure comprising a first restriction scheme type indicating that the sample of the track is associated with an essential sample group description;
wherein the first restricted scheme description data structure further comprises a second restricted scheme description data structure describing a transformation to be applied to the sample.

2. The method of claim 1, wherein the second restricted scheme description data structure further comprises a parameter of the transformation.

3. The method of claim 1, wherein the descriptive metadata further comprises an indication indicating a processing order of the transformation relatively to another transformation to be applied to the sample.

4. The method of claim 3, wherein the indication indicating the processing order is comprised in the essential sample group description.

5. The method of claim 3, wherein the descriptive metadata further comprises another essential sample group description describing the another transformation or essential information for the sample.

6. The method of claim 3, wherein the first restricted scheme description data structure further comprises a third restricted scheme description data structure describing the another transformation to be applied to the sample.

7. The method of claim 1, wherein only the first restricted scheme description data structure comprises an indication of the un-transformed format of the sample.

8. The method of claim 6, wherein the second and third restricted scheme description data structures are comprised in a scheme information data structure in the first restricted scheme description data structure.

9. The method of claim 1, wherein the generated track is encapsulated in an ISOBMFF-based file.

10. A method for processing encapsulated media data, by a processing device, the method comprising:
obtaining, from a track of the encapsulated media data, a sample and descriptive metadata, the descriptive metadata comprising:
an indication that the track is restricted, and
a first restricted scheme description data structure comprising a first restriction scheme type indicating that the sample of the track is associated an essential sample group description, wherein the first restricted scheme description data structure further comprises a second restricted scheme description data structure describing a transformation to be applied to the sample, and
applying the transformation to the obtained sample.

11. The method of claim 10, wherein the second restricted scheme description data structure further comprises a parameter of the transformation.

12. The method of claim 10, wherein the descriptive metadata further comprises an indication indicating a processing order of the transformation relatively to another transformation to be applied to the sample.

13. The method of claim 12, wherein the indication indicating the processing order is comprised in the essential sample group description.

14. The method of claim 12, wherein the descriptive metadata further comprises another essential sample group description describing the another transformation or essential information for the sample.

15. The method of claim 12, wherein the first restricted scheme description data structure further comprises a third restricted scheme description data structure describing the another transformation to be applied to the sample.

16. The method of claim 10, wherein only the first restricted scheme description data structure comprises an indication of the un-transformed format of the sample.

17. The method of claim 10, wherein the media data is encapsulated in an ISOBMFF-based file.

18. A non-transitory computer-readable storage medium storing instructions of a computer program for implementing the method according to claim 1.

19. A processing device comprising a processing unit configured for carrying out each step of the method according to claim 1.

20. A processing device comprising a processing unit configured for carrying out each step of the method according to claim 10.
